(19) United States
(12) Patent Application Publication
(10) Pub. No.: US 2008/0218128 A1
(43) Pub. Date: Sep. 11, 2008

(54) Self-generation type charging battery assembly

(76) Inventor: Leo Hipom Kim, San Leandro, CA (US)

Correspondence Address: Leo Hipom Kim, 16034 Selborne Dr, San Leandro, CA, 94578, US

(21) Appl. No.: 11/729,142

(22) Filed: Mar. 28, 2007

(30) Foreign Application Priority Data
Mar. 8, 2007 (KR) 10-2007-0023075

(51) Int. Cl. H02J 7/00

(52) U.S. Cl. 320/137

(57) ABSTRACT

Disclosed is a self-generation type charging battery assembly, which is devised to provide a battery capable of being charged by self-generation without using a separate charger, by combining a constituent for generating electric power through the reciprocal movement, a constituent for converting the generated alternating current into direct current, and a battery chargeable by the converted current. In the present invention, when the magnet is moved reciprocally in the generation tube with respect to the winding coils, alternating current is generated in the coils by the magnetic force and it is converted into direct current during the passage through the diode and charged into the battery. The constituting elements of the present invention can be assembled into a casing so that it can be used almost permanently without separate recharge. Meanwhile, the battery assembly of the present invention is provided as one battery assembly, which can be used at any application such as a clock, a telephone, a flashlight, a camera, and the like in addition to a wireless remote controller, by fabricating it according to the size and standard.

### BACKGROUND OF THE INVENTION

1. Field of the Invention

The present invention relates to a self-generation type charging battery assembly, which is devised to provide a battery charged by using a well-known self-generation principle without using a separate charger.

Thus, the charging battery assembly of the present invention can be charged by means of self-generation by the shaking of the self-generation type battery after grasping it with hand, or shaking a wireless remote controller with the battery installed therein.

As a result, according to the present invention, it is possible to prevent the troublesome random exchange and frequent purchase of the battery, to reduce the purchasing expense, and to solve the serious environmental pollution originating from the discard of the waste battery radically.

2. Background of the Related Art

In general, a battery is an important indispensable power supply means for devices, which have been developed along with the progress of the human civilization and industry, such as a clock, a wireless remote controller, a camera, a radio, a telephone, a walkie-talkie, and several operation toys. In this regard, numerous kinds of batteries have been generally known in the field.

Meanwhile, the battery can be divided into two types: one is a charging battery assembly fabricated to be rechargeable repeatedly by using a separate charger, and the other is a battery which should be exchanged after the termination of its use without the recharging.

Thus, the present invention is directed to a self-generation type charging battery assembly which can be charged without a separate charger and requires no exchange of the battery.

### SUMMARY OF THE INVENTION

Therefore, the present invention has been made in an effort to solve the above problems occurring in the prior art, and an object of the present invention is to provide a self-generation type charging battery assembly, which is devised to be able to charge the battery by the self-generation without using a separate charger.

Thus, the present invention generates alternating current by moving a magnet reciprocally with respect to winding coils, and the generated current is converted into direct current appropriate for the battery and is provided to charge the battery.

In addition, the present invention provides a self-generation type charging battery assembly, which is devised to provide a battery capable of generating current and charging it without any separate charger, and comprises a constituent constructed to generate current by winding coils in a generation tube shaped as a bobbin and inserting a magnet in the generation tube so that it can move reciprocally with respect to the magnet, and a constituent for converting the generated current so that it can be charged.

Thus, according to the present invention, when the magnet is moved reciprocally in the tube with respect to the wound coils, alternating current AC is generated in the coils by the magnetic force, and then generated current is converted into direct current via a diode and charged into the battery. In this regard, the operating constituents are supplied as a battery assembly provided in a casing by the connection and combination, and can be applied to such applications such as a wireless remote controller, a clock, a telephone, a flashlight, a camera, and the like according to the standard.

To accomplish the above objects, according to the present invention, there is provided a self-generation type charging battery assembly comprising: an upper cover having a positive (+) terminal; a terminal plate provided with an electric contact terminal contacting with the positive (+) terminal and an electric contact ring connected to an earth disposed at the inside of a casing; a printed circuit board provided with a battery to which generated current is charged and a diode; a generation tube provided with an upper vane, a lower vane, a winding ring of coils, and a shield plate, the generation tube being connected to jump terminals by winding the coils therearound and having a magnet having high magnetic force embedded therein so as to be closed by a shock absorption plate at a lower surface thereof a magnet; and a lower cover for sealing the bottom surface thereof.

### BRIEF DESCRIPTION OF THE DRAWINGS

The above and other objects, features and advantages of the present invention will be apparent from the following detailed description of the preferred embodiments of the present invention in conjunction with the accompanying drawings, in which:

FIG. 1 is a perspective view illustrating a “plus (+)” terminal direction of a self-generation type charging battery assembly of the present invention;

FIG. 2 is a perspective view illustrating a “minus (−)” terminal direction opposing to FIG. 1;

FIG. 3 is an exploded perspective view for easily explaining a structure of the self-generation type charging battery assembly of the present invention;

FIG. 4 is a perspective view illustrated in half-section for facilitating the understanding of the inner structure of the self-generation type charging battery assembly of the present invention;

FIG. 5 is a partial cross-section explaining the structure of the battery assembly in detail; and

FIG. 6 is a circuit diagram of the self-generation type charging battery assembly according to the present invention.

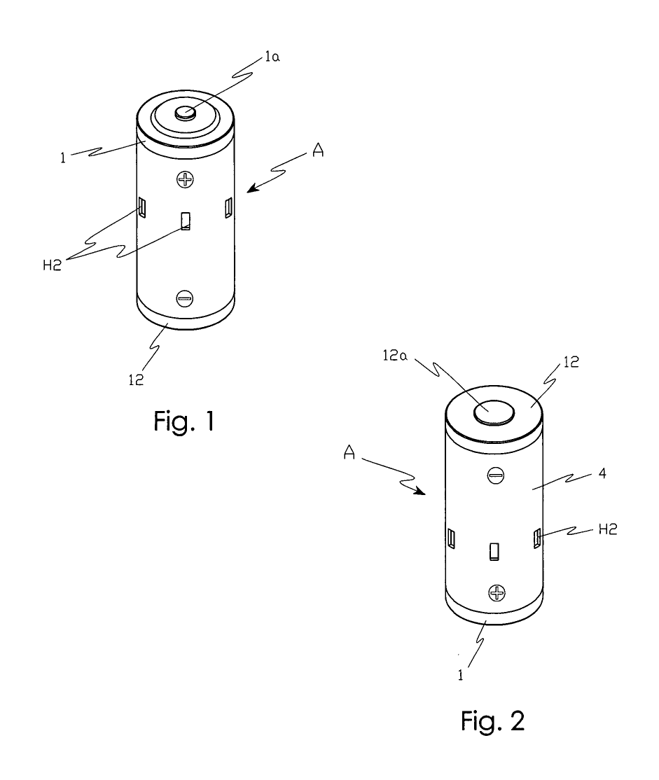

### DETAILED DESCRIPTION OF THE PREFERRED EMBODIMENT

Reference will now be made in detail to the preferred embodiment of the present invention in connection with the attached drawings. In the whole specification and drawings, same numerals are indicated for the same constituting elements.

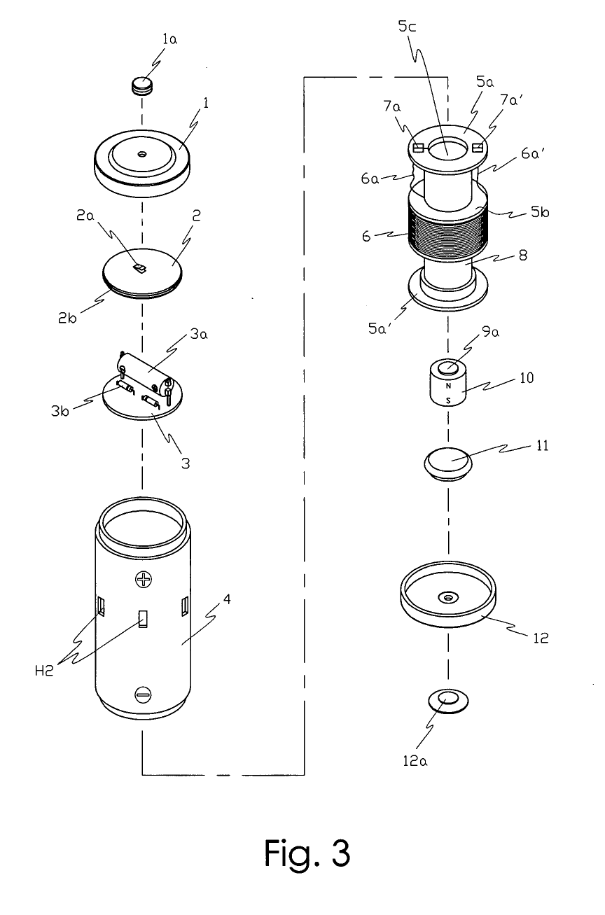

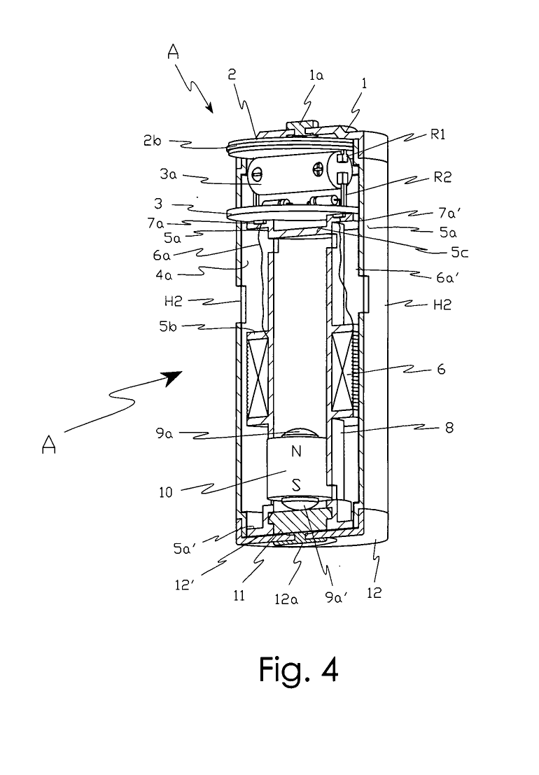

As shown in FIG. 3, the self-generation type battery assembly of the present invention comprises an upper cover 1 having a plus (+) terminal 1a; a terminal plate 2 having an electric contact terminal 2a and an electric contact ring 2b; a printed circuit board 3 provided with a battery 3a and a diode 3b; a casing 4 formed with through holes H1, H2 and plus and minus indications at upper and lower surfaces; a generation tube 8 provided with upper and lower vanes 5a, 5b having electric contact terminals 7a, 7a′, a coil winding ring 5b, a shield plate 5c, and coils 6; a magnet 10 having shock absorption rubbers 9a, 9a′; a shock absorption plate 11 disposed at a lower surface of the generation tube 8; and a lower cover 12 having a minus (−) terminal 12a.

When the present invention is explained more concretely, the upper cover 1 having a positive (+) terminal 1a is installed on the upper surface of the casing 4, the terminal plate 2 is provided with the electric contact terminal 2a at the center thereof so that it is connected to the positive (+) terminal 1a, and is provided with the electric contact ring 2b at a peripheral surface so that it is connected by close contact with an earth 4a disposed at the inside of the casing 4, the printed circuit board 3 is provided with the battery 3a connected to the terminal plate 2 and the diode 3b.

Further, while the generation tube 8 is provided with the upper and lower vanes 5a, 5a′ and the coil winding ring 5b, each having a same diameter at the mid portion thereof, the upper vane 5a is provided with jump terminals 7a, 7a′ at both sides and the coil winding ring 5b is provided with predetermined numbers of coils 6, so that both ends 6a, 6a′ of the coils, that is, a starting point of the winding and a finishing point of the winding of the coils, are connected to the printed circuit board 3 via the jump terminals 7a, 7a′ to thereby enable the current of the coils 6 in the generation tube 8 to be charged to the battery 3a.

In addition, after the magnet 10 is inserted into the generation tube 8, the generation tube 8 is closed completely by the shock absorption plate 11 at the open lower surface after the insertion of the magnet 10, and the casing 4 is completely sealed by the lower cover 12 at the lower surface to accomplish the assembly. In this instance, a conducting pate 12′ is disposed at the inner surface of the lower cover 12 to be connected to the earth 4a disposed at the inside of the casing 4 so that the current of the battery 3a is applied to the positive (+) terminal 1a and the minus terminal 12a.

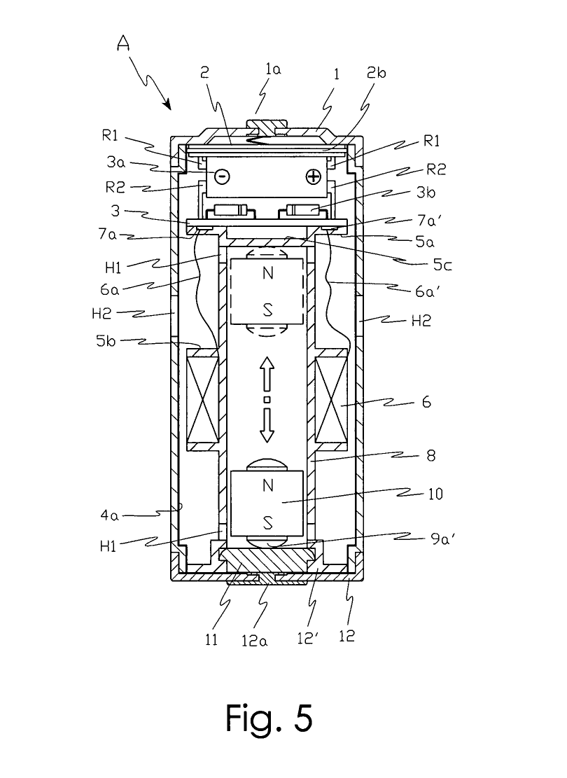

With regard to FIG. 5, the construction of the present invention will be described in more detail below.

The positive (+) terminal 1a is buried in the center of the upper cover 1 so that it is connected to the electric contact terminal 2a at the center of the electric contact ring 2b. In this instance, the positive (+) terminal 1a and the electric contact terminal 2a are connected to each other by means of welding or a plate spring.

Moreover, the electric contact ring 2b of the terminal plate 2 is connected by close contact with the earth 4a of the casing 4.

Also, the plus and minus electrodes of the battery 3a are connected to each other by means of a connection member R1, and the charging battery assembly 3a is connected to the printed circuit board 3 by means of another connection member R2, and the printed circuit board 3 is connected to the jump terminals 7a, 7a′ of the upper vane 5a.

In addition, the jump terminals 7a, 7a′ are connected to both ends 6a, 6a′ of the coils of the generation tube 8, and the both ends 6a, 6a′ of the coils are connected from the starting point to the finishing point of the coils 6.

Then, the inside of the generation tube 8 is closed by the shock absorption plate 11 after the insertion of the magnet 10 from the open lower surface, and the lower cover 12 is closed sealably from the open lower surface to thereby finish the assembly, after the generation tube 8 is installed at the inside of the casing 4, resulting in the provision of the self-generation type charging battery assembly A of the present invention.

As described above, the self-generation type charging battery assembly A of the present invention is provided at the sealed assembly state, so that it cannot be dismantled optionally or arbitrarily. As a result, the battery can be charged without a charger.

Hereinafter, the action of the self-generation type charging battery assembly of the present invention will be explained more concretely below.

When the self-generation type charging battery assembly of the present invention is shaken reciprocally along the longitudinal direction of the battery assembly with gripping it by the hand, the magnet installed in the generation tube 8 is moved reciprocally to thereby generate current.

In other words, referring to the drawings illustrating the self-generation type charging battery assembly A of the present invention, when the battery assembly is shaken quickly in the upward and downward directions, the magnet becomes to move reciprocally in the generation tube 8 by the movement force of the generation tube.

In this instance, when the magnet 10 is moved to the upper side, the upper shock absorption rubber 9a collides with the shield plate 5 and rebounds in the reverse direction, and when the reciprocating magnet 10 is moved to the lower side, the shock absorption rubber 9a′ collides with the shock absorption plate 11 and rebounds in the reverse direction. Thus, the repeated reciprocation movement of the magnet is accomplished.

Meanwhile, when the magnet 10 is moved up and down reciprocally as described above, for example, when the magnet 10 is moved in the upward direction, vacuum pressure produced in the upward direction is discharged through the through-hole H1 and concurrently absorbing outer air through the opposing through-hole H2. Thus, the magnet 10 moves reciprocally quickly together with the inflow and discharge of the outer air and the inner air of the generation tube 8 through the through-holes H1, H2 of the casing 4.

Accordingly, the current thus generated in the winding coils 6 is charged to the battery 3a through both ends 6a, 6a′ of the coils, the printed circuit board 3, and the diode 3b, and the charged current can be applied to any desired device or currently using device through the plus and minus terminals 1a, 12a.

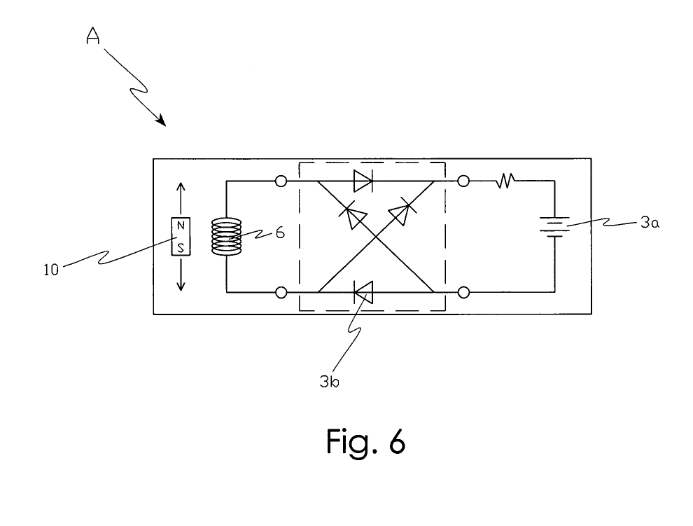

In this instance, the current generated in the winding coils 6 is alternating current AC, and the alternating current AC is converted into direct current DC when it passes through the diode 3d, for example, a diode bridge illustratively shown in FIG. 6, and is charged to the battery 3a.

When the charged current of the battery 3a installed in the self-generation type charging battery assembly A of the present invention has been dissipated, the charging battery assembly A can be separated from the using device, and can be shaken quickly as described above. Then, the magnet 10 moves reciprocally through a hollow of the coils 6 to thereby initiate the current generation and recharge the battery 3a so that it can be used again.

As described above, the characteristics of the present invention resides in that separate power source is not required for the charging, a separate charger is not required for the charging, and it is possible to charge battery only by shaking the self-generation type charging battery assembly A of the present invention with gripping it by the hand so that the charging of the battery can be accomplished at any time and at any place by everybody.

In addition, in case of driving a vehicle with carrying the self-generation type charging battery assembly, it is possible to instantly charge the battery by shaking it and use it, when the vehicle becomes out of order, and it is also possible to instantly charge the battery by shaking it and use it in the course of climbing or outdoor activities, when the self-generation type charging battery assembly of the present invention is carried to remove apprehensions caused by the discharge of the battery.

Moreover, the present invention can provide the advantage of effectively preventing the environmental pollution caused by the dispatched and discarded waste battery in the past.

While the present invention has been described with reference to the particular preferred embodiments, it is not to be restricted by the embodiments but only by the appended claims. Also, it is to be appreciated that those skilled in the art can change or modify the embodiments without departing from the scope and spirit of the present invention, and such modifications are wholly pertained to the scope of the appending claims.

What is claimed is:

1. A self-generation type charging battery assembly comprising:
an upper cover having a positive (+) terminal;
a terminal plate provided with an electric contact terminal contacting with the positive (+) terminal and an electric contact ring connected to an earth disposed at the inside of a casing;
a printed circuit board provided with a battery to which generated current is charged and a diode;
a generation tube provided with an upper vane, a lower vane, a winding ring of coils, and a shield plate, the generation tube being connected to jump terminals by winding the coils therearound and having a magnet having high magnetic force embedded therein so as to be closed by a shock absorption plate at a lower surface thereof a magnet; and
a lower cover for sealing the bottom surface thereof.

2. The self-generation type charging battery assembly according to claim 1, wherein the coils are wound around the generation tube having the printed circuit board, which is provided with the battery and the diode, the winding ring of coils, and the shield plate, and an opened lower portion of the generation tube is sealed through the insertion of the magnet into the generation tube.
